(19) United States
(12) Patent Application Publication
(10) Pub. No.: US 2002/0198685 A1
(43) Pub. Date: Dec. 26, 2002

(54) Slip and fall decetor, method of evidence collection, and notice server, for uisually impaired persons, or the like

(76) Inventor: W. Stephen G. Mann, Toronto (CA)

Correspondence Address: W. Stephen G. Mann, Suite 701, 284 Bloor Stree West, Toronto, ON, M5S 3B8, CA

(21) Appl. No.: 10/145,309

(22) Filed: May 15, 2002

(30) Foreign Application Priority Data
Jun. 26, 2001 (CA) 2351660
Jul. 16, 2001 (CA) 2354114
Jun. 26, 2001 (CA) 2351660

(51) Int. Cl. G06F 15/00; G06F 17/40

(52) U.S. Cl. 702/187

(57) ABSTRACT

Means, apparatus, and method of automatic evidence collection of health hazards such as heart irregularities, slip and fall accidents, or the like, assists the elderly, the visually impaired, or the like, in notifying for emergency assistance, as well as retroactively capturing evidence of the situations that led to the accident, and possibly also automatically serving, or assisting in the serving of notice to parties potentially responsible. In one embodiment a wearable camera system collects evidence of a slip-and-fall incident and the conditions that led up to the incident. In another embodiment, a wearable camera system documents the environmental conditions that might have contributed to cardiac stress, as captured by a heart monitor.

### FIELD OF THE INVENTION

The present invention pertains generally to automatic detection of slip and fall accidents and methods of evidence collection, automatic notification, or the like.

### BACKGROUND OF THE INVENTION

With the growing population of elderly, along with improvements in health care, general awareness of safety issues (e.g. improved fire safety, improved building codes, and the like), there is an increase in life expectancy for many people.

Although much in the way of safety has been improved, there are many situations where safety is lacking. For example, many large shopping complexes, airports, and the like, are actually still quite unsafe. For example, in St. John's airport in Newfoundland, Canada, the rough ceramic tiles which once afforded very good traction are currently being torn out and replaced with large smooth shiny marble tiles, resulting in an unsafe condition, especially in view of the inclement weather typical of Newfoundland. Large sheets of glass are used for railings, and sometimes the edges are unfinished. Glass stairs with no risers are also becoming popular. Many buildings are built as monuments to an architect's grandiose ego, rather than for serving the occupants.

Additionally, there may exist unsafe conditions within these buildings, such as loose propane cylinders, fire extinguishers piled up in a main walkway, or the like, combined with poor lighting, and poor visibility.

The growing population of visually impaired individuals, combined with an increase in “bigness” (bureaucracy, grandiosity, etc.) of building complexes, creates a unique problem.

This “bigness” is what leads architects to select smooth shiny marble instead of flooring materials like Johnsonite Roundel Raised Round. There is a “grandness” (if not grandiosity) in smooth shiny marble that is befitting to large multinational corporations that retreat further and further from accountability.

Take for example, a slip and fall incident in an airport such as St. John's airport. The various responsible parties may attempt to evade liability. The airline, e.g. Air Canada, who uses the space, might blame the airport authority. The airport itself was privatized recently, so the airport is run by a private corporation, but is also under some kind of relationship with the government. Additionally, there could be an issue of blame to other entities such as private contractors and subcontractors responsible for cleaning, maintaining, or doing construction in the airport.

An individual who has slipped and fallen in the airport might end up being hospitalized, perhaps with a head injury, or the like.

After suffering a head injury, it is difficult for this individual to remember what happened, and yet to get any kind of redress, a good memory of what happened might be essential.

Although the injured party might be able to rely on video surveillance as evidence, it is difficult for an injured party to get this data. For example, responsible parties may either deliberately erase the surveillance data, or they may simply show little or no interest in preserving it as evidence. Particularly when surveillance data would benefit the injured party, the video surveillance data is often lost, and whether this is a deliberate loss, or merely further accidental negligence on the part of the responsible parties, such loss is quite commonly reported in news media, and the like. (An example, “the encounter at the detox center was videotaped, but detox staffers lost the tape”, is cached in http://wearcam.org/arrested_for_not_driving_drunk_videotape_lost.htm.)

It is easy for a small organization to “conveniently” lose a videotape or computer file of video data in situations when the tape or data would incriminate the organization. In a large bureaucratic entity like an airport, although data loss may be less common, it is doubtful that a person suffering a recent head injury (and therefore somewhat incapacitated) will have the energy or perseverance to jump through all of the bureaucratic barriers involved in obtaining copies of surveillance data as evidence, or even ensuring that such data is preserved.

This problem is particularly acute in situations where the number of entities increases. For example, in an international airport involving multinational corporations as well as governments from various countries, it is very difficult for a mere mortal individual to so much as find out who's responsible, let alone get hold of any surveillance data before it is erased.

Consider a person who slips and falls passing through Customs and Immigration. Such a person has to first contend with who might be responsible for unsafe conditions, across international boundaries. Did the person slip and fall before or after they crossed the red line at the customs counter. Did they slip and fall before or after their passport was stamped? In which country would the injury be considered to have taken place, if it happened while passing from one country to another?

Lawsuits serve an important role, not just for the injured party, but for everyone using the airport, because the fear of lawsuits is one of the important elements that keeps responsible parties concerned about safety issues.

Thus an important element of public safety is accountability of all parties, no matter how big or multinational.

Moreover, the time window for serving notice to government entities is often much shorter than the time window for serving notice to private corporations. For example, governments often need to be put on notice within ten days of an incident, whereas private corporations can be served notice much later after an incident.

In many cases, an injured party could easily take more than ten days to recover, and thus miss the time window in which to serve notice, especially given the bureaucratic nature of multi-government incidents in international airports, customs offices, and the like.

Personal monitors are known in the art. Einthoven is considered to be the inventor of the electrocardiograph (for which he won the nobel prize).

More recently, portable heart monitors have been constructed, as by Norman Jeff Holter who invented, designed, and built a 75 pound backpack rig for capture and wireless transmission of ECG waveforms (Holter N J, Generelli J A. Remote recording of physiologic data by radio. Rocky Mountain Med J. 1949;747-751).

### SUMMARY OF THE INVENTION

The invention continuously logs personal data into a circular buffer, or the like. Personal data refers to internal personal data, incoming personal data, or the like.

Internal personal data includes biological signals, such as may be measured by biosensors including, for example, electrocardiogram (ECG), electroencephalogram (EEG), electrooculogram (EOG), electromyography (EMG), skin conductivity, respiration, blood-sugar levels, orientation of the body (as might be desired to determine slip-and-fall status), movement of the body as measured therefrom, and the like.

Incoming personal data includes measurements of such quantities as eyeward bound rays of light, earward bound acoustical signals, body bound temperature (e.g. the temperature of the air in the room around the body), and various other measurements of environmental conditions at or near the point of contact with the body. Incoming personal data might, for example, include visual memory of images of potential witnesses who the wearer of the apparatus of the invention may wish to contact at a later date.

Internal personal data may also be derived from incoming personal data. For example, body orientation (as indicative of a slip-and-fall) may be determined by looking at incoming video data, of a body-worn camera, to estimate the motion of the camera, as described in Intelligent Image Processing, published by John Wiley and Sons, 2001, http://wearcam.org/textbook.htm providing a reference link.

Sensors that measure biological signals, sensors that capture sensory-bound information from the environmemnt, etc., are directed to a personal data recorder that records the personal data. This recording of personal data may be lifelong, or for extended periods of time, or it may be temporary, or a combination of both. Lifelong videocapture together with blood-sugar levels, for example, helps diabetic persons correlate blood-sugar levels with activities such as eating, by capturing a food record of intake. Moreover, in situations such as food poisoning, the wearer has a record that may provide evidence of misconduct that the food vendor or other establishments might wish to hide. For example, if we were to rely only on video surveillance cameras in a restaurant, these cameras may, either by negligence or deliberate obfuscation perpetrated by the restaurant owner, fail to show the same evidence as might be captured by the customer.

Preferably there is a lifelong personal data capture at a low data rate combined with a high speed high bandwidth personal data capture at a higher data rate, where the high speed high bandwidth personal data capture record is in a circular buffer or similar structure, such as an overwriting buffer.

An overwriting buffer is one in which information comes in and then degrades or becomes overwritten.

A partially overwriting buffer ramps the data from high bandwidth to low bandwidth on a varying time scale.

Preferably the buffer of the invention is at least partially overwriting.

Preferably the high speed buffer ramps down to the low speed buffer, in a soft manner, not just abrupt as with a circular buffer. This data is captured at high resolution and bandwidth (e.g. high definition), and then gracefully degraded. For example, for eyeward bound rays of light, these rays of light that would otherwise pass through the center of projection of an eye of a wearer of special eyeglasses are diverted into a sensor array and captured and compressed. As time goes by, the images are re-encoded at higher and higher levels of compression, so that the images get noisier and noisier or grainier and grainier as time goes by.

This creates a soft continuous forgetting factor, such that more recent images are of high quality and older images are of lesser quality. Thus there need not be an abrupt circular buffer transition between saved and not saved.

However, when an incident is detected, such as a slip and fall, or a phyisal assault, or a heart attack, the ramping down of data quality stops or slows down, and the data of the incident is preserved in higher quality than it would normally be preserved.

This transition is preferably soft, in the sense that a probability of each of these conditions is estimated, and the more probable an incident, the more slowly the data is degraded with time.

The degradation with time is preferably also modulated across channels by a data degradation controller, or data degradation modulator, so that for example, if a heart attack is determined to have happened with high probability, then the timedown (time-rampdown e.g. time-compression or degradation) of ECG is slowed down greatly or stopped altogether while the timedown of eyeward bound video image data is slowed down to a lesser degree. However in the event that the system detects, with high probability, that a physical assault had occurred, the timedown of the video image data is slowed down greatly, or stopped altogether.

Thus an incident detecter detects the nature of the incidents, and an incident capture controller responds to the probability map across multiple possible incident channels.

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1 is a diagram showing an intelligent incident capture, detection, alert, and notice server.

FIG. 2 is diagram showing the details of display to others, in a heart patient name tag embodiment of the invention.

FIG. 3 shows the operation of an embodiment of the invention using a heart monitor.

FIG. 4 shows a system that makes use of body modification.

### DETAILED DESCRIPTION OF THE PREFERRED EMBODIMENTS

While the invention shall now be described with reference to the preferred embodiments shown in the drawing, it should be understood that the intention is not to limit the invention only to the particular embodiments shown but rather to cover all alterations, modifications and equivalent arrangements possible within the scope of appended claims.

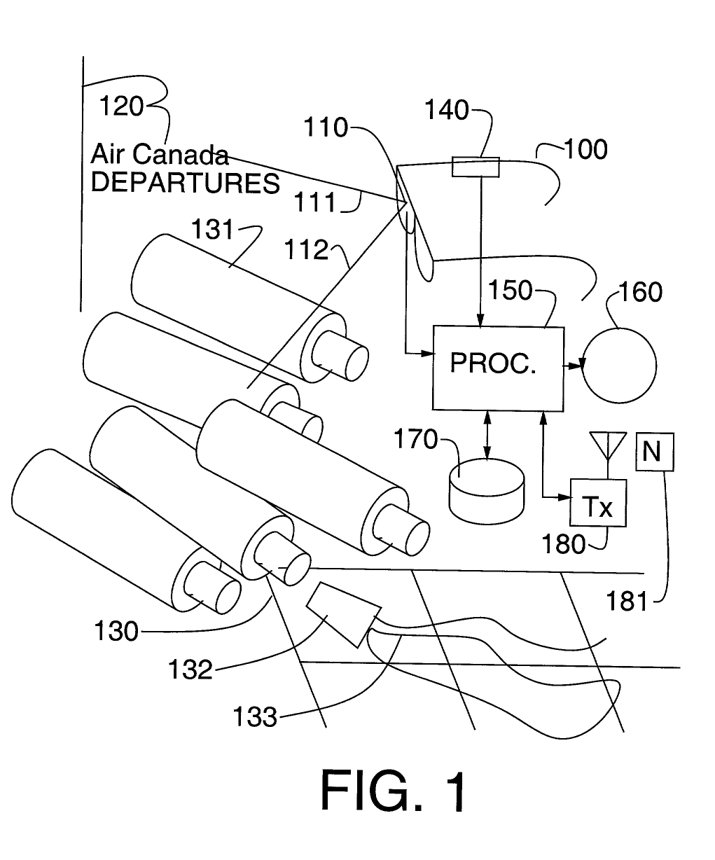

FIG. 1 depicts an intelligent incident capture, detection, alert, and notice server. Without loss of generality, this embodiment comprises eyeglasses 100 with a body worn processor and sensor system 150.

System 150 is preferably worn in a shirt pocket on the left side of the body, e.g. the left pocket of a typical business shirt. Openings in the back of the shirt may be provided, for electrodes, or the electrodes may stick through the shirt. Depending on seriousness of heart condition, a greater or lesser degree of electrode facility may be provided, ranging from none, to complete shaving of the chest and application of semipermanent electrodes with Dermabond (TM) wound closure material. Processor 150 is preferably in two parts, comprising a minimal processor for ECG capture and a fullblown processor for being a fully featured wearable computer (email, web, business presentations, reality mediator, etc.). Thus the minimal part of processor 150 may remain attached by Dermabond would closure material or by being implanted within the body, while the full-blown processor is worn externally, even outside clothing, or simply placed in a left side shirt pocket to be near the minimal processor.

In this manner, lifelong ECG may be captured without loss of data during bathing. During bathing the outer full-blown processor may be removed together with clothing and the internal portion may remain attached so that it can continue to collect data.

A rampdown buffer 160 preferably gracefully and gradually degrades data over time, so that the data takes less and less disk space on disk 170 over time. In alternative (less preferred) embodiments, buffer 160 may simply be a circular buffer. The more preferred gradual rampdown buffer will, however, allow lifelong ECG, lifelong videocapture, and the like, for improved health diagnostics over many years.

An incident detector 140 detects anomalous situations, such as a slip and fall. Thus incident detector 140 may be referred to as an anomaly detector. A satisfactory incident detector 140 comprises a tilt and motion sensor such as an array of gyroscopic inertial systems and mercury switches. However, in the preferred embodiment, incident detector 140 is a computer program running on processor 150. In this embodiment, incident detector 140 analyzes data from various personal sensors, and constructs a decision matrix upon which to develop inference weights.

Incident detector 140 may, for example, run a VideoOrbits algorithm on video from a right EyeTap (TM) 110. EyeTap 110 being responsive to rays of right eyeward bound light 111 and 112, can determine if there is a loss of motion indicative of a slip and fall. In particular, if the Orbit of the motion does not change, as might be the case when the wearer (victim) of eyeglasses 100 is motionless on the floor, even though there is motion from other persons walking around the fallen victim, then a slip and fall incident probability node is increased, to signal to processes running in processor 150 that there is a high probability that a slip and fall has occurred.

The VideoOrbits algorithm is well known, as described in the textbook Intelligent Image Processing published by John Wiley and Sons (author S. Mann, 2001, http://wearcam.org/textbook.htm).

In this invention, the VideoOrbits system is used to distinguish between motion of people walking around the airport, and head motion of the wearer of the eyeglasses. When there is no head motion of the wearer of the eyeglasses 100, the slip and fall element of an incident probability vector is increased appropriately.

A threshold applied to the incident probability vector signals an alarm by way of transmitter 180, to call for medical attention, as well as to retroactively transmit personal information e.g. ECG from previous 10 minutes before the incident, as well as live audiovisual information from the previous 5 minutes before the incident. Preferably the audiovisual content is timeramp compressed, such that a chirping framerate is used. An example of a chirping framerate would be if a picture from one second before the incident, then one from 2 seconds before the incident, and then one from 4 seconds before the incident, . . . , one from 256 seconds before the incident, one from 512 seconds before the incident, and so on, were transmitted. This would be a logarithmic chirp, on the chirping timeramp, with log base 2.

The quality of compression may also be timeramped, such as by compressing older images more heavily and compressing more recent images less, so that the incident can be viewed clearly while the entire day that led up to the incident, from early morning, arrival at the airport, passing through customs, walking to the gate, etc,. may be viewed with progressively clearer quality, as we move closer in time to the incident.

Other quantities such as ECG, EEG, EMG, and the like can also be similarly timeramped, although the greatest benefit of timeramp will be in the broadband of the video.

Timeramp need not be limited to log base 2, or to logarithmic at all. Moreover, since ECG takes up so little storage space, the video may be timeramped but synchronized with ECG that is not timeramped. The synchronization of timeramped and non-timeramped signals is attained by maintaining timestamps in the timeramped signal with respect to the non-timeramped signal. For example, each frame of video contains a header for example in the comment field of a jpeg image, as by, for example, using the rdjpgcom and wrjpgcom commands, as described in the cjpeg program documentation. See Wallace, Gregory K. “The JPEG Still Picture Compression Standard”, Communications of the ACM, April 1991 (vol. 34, no. 4), pp. 30-44. The video frame timestamp indexes it into the ECG waveform, which, running at a constant sample rate, is of known time evolution.

As an example of a scenario where the invention might be used, consider a passenger walking into St. John's airport in Newfoundland on a cold and stormy day in February. The passenger encounters first a smooth shiny marble floor 130 that is in the process of being installed. Various debris, such as construction materials, screws, boxes of .22 calibre bullets for nailguns, as well as the loaded guns, are left on the floor where passengers are expected to walk from the baggage check in counter to where they board the aircraft.

The marble floor is befitting to the grandiosity of the airport, but provides little traction for persons coming in with snow-laden footwear. Additionally, a spilled coffee cup 132, provides some coffee 133 upon the surface of the floor 130, where the passenger slips and falls.

A pile of fire extinguishers 131 has been placed on the floor by airport staff or their contractors, to provide debris and clutter to further frustrate the passenger's ability to walk, especially if the passenger's eyeglasses were already damaged by Air Canada staff, such that the passenger does not see the debris.

The invention helps to solve the problem of accountability that is now present in much of the airline industry. The lack of accountability is evident in, for example, the way that Air Canada staff often deliberately conceal their name tags. Besides making it easy for a terrorist with an Air Canada uniform to take position behind an unoccupied counter, this lack of unaccountability makes it difficult for the passenger to hold staff responsible for damages, as described in the http://airfraud.com web site.

However, a damage recording device of the invention keeps track of staff that the passenger has interacted with, and provides personal safety. As the passenger lands in the pile of fire extinguishers, the memory of the incident is preserved despite the head injury.

Fire extinguishers are supposed to be for safety, but here they are dangerous. Nevertheless, notice may be automatically served by notice server 181, even when the passenger is suffering from injury.

Thus if the wearer slips and falls, and is unconscious, a connection to a doctor familiar with the wearer's particular situation will be established. Thus local hospitals may be put in touch with the medical situation of the wearer. Additionally, notice is automatically served to suspects and suspected perpetrating organizations. Using Global Positioning, or other form of egolocation, the system finds its own location, and sends its location with the notice, so that a remote notice daemon running on a remote server (the program is typically called “noticed” as might show up in a computer command like “ps” to show that the notice daemon is running) can serve notice. The notice daemon dispatches an intelligent agent or other computer program or subroutine that finds who's responsible for the property management or space where the incident took place. The notice daemon then automatically finds the address and contact information of the management or space, and puts the appropriate entities on legal notice of their liability. In particular, if the notice daemon determines that an incident took place on public property, it puts the city on notice, as well as other government entities. Letters are automatically sent, even if the patient is unconscious and unable therefore to write letters of notice.

Whether an incident comprised a physical assault of the wearer of eyeglasses 100, a slip and fall, or even a situation in which the wearer would be asked or required to remove the personal safety device, the incident would still be logged and data captured and transmitted. Thus the perpetrator would be unable to deliberately destroy evidence of the incident.

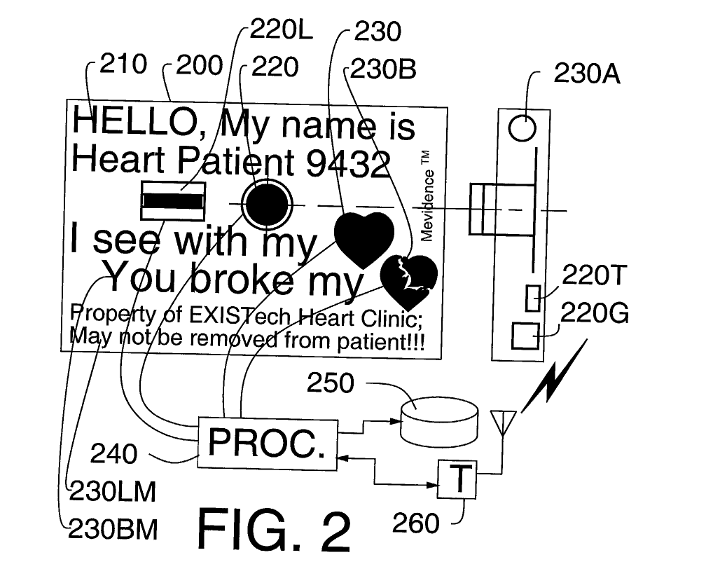

FIG. 2 depicts an intelligent cardiable (TM) name tag, as to be sold under the tradename EseeG by EXISTech Corporation. A name tag 200 bears a place 210 for printing a name. The name tag may also display fixed messages such as message 230LM that indicate that the device is not to be removed from the heart patient. Such a message may serve as a liability message, for holding persons attempting to tamper with name tag 200 liable. Fixed messages may be printed in ink on the name tag 200. Variable message such as message 230BM such as by way of light emitting diode displays, liquid crystal diode displays, or the like, show a message that is responsive to the heart waveform, or the like. A processor 240 monitors the heart, while capturing video from a camera 220 built into the name tag. A lamp 220L may also turn on when certain conditions (set by the processor) are met.

The processor 240 detects irregularity, such as cardiac arrhythmias (the sometimes dangerous abnormalities in the rhythm of the heartbeat) and saves pictures that might provide evidence of what caused the cardiac irregularity. Preferably the processor always captures pictures into a circular buffer or storage media 250, so that when an irregularity of the heart is detected, the images may be saved rather than overwritten. Alternatively, a soft continuous forgetting factor, where more recent images are saved at high quality and older images are reduced in quality (more severely compressed over time) is implemented. This embodiment therefore eliminates the need for an abrupt circular buffer transition between saved and not saved images.

A transmitter 260 has the possibility of transmitting some images to a remote site. Also a receiving device 220G or transceiver 220T allows for data to be received from other similar devices.

An annunciator 230A adds an amusement or warning feature, so that others can see the heart beat or pulse of the wearer, or there may be symbols like symbol 230 that flashes to show each heart beat, or a broken heart symbol 330B to show a failure mode or to indicate displeasure.

In one mode of operation, if the patient's heart exceeds a certain threshold, a flash lamp such as lamp 220L is activated together with camera 220, and then the message changes from “I see with my” to “You broke my”, and from symbol 230 to symbol 230B.

This serves as an evidence annunciator, which is a system to take a picture of the environment or situations causing stress, and then to justify the taking of the picture by the indicia. Thus for example, a perpetrator of an attack might activate the device, where it may then be explained to the perpetrator (explained by the wearer) that the device was actuated automatically and the evidence annunciator serves to diffuse the anger that would otherwise ensue if the act of taking the picture were perceived by the attacker as having been deliberate.

Thus symbols 230 and 230B, as well as variable text 230BM may serve the role of photographic justifier.

Additionally, the system need not transmit all images, but, rather, with simply a possibility of transmitting the images, there is provided a deterrent against crime. Also, the fact that one heart monitor name tag can transmit to another, and therefore there being the possibility that each name tag can function as a store and forward node, means that a perpetrator of crime might never know for sure that evidence was not captured. This inability to contain evidence may help in making the evidence contagious so that it can spread from one heart monitor to another.

Such a contagion possibility generator need not be implemented in all heart monitors to stop crime. For example, if 100 heart monitors are made, and only two or three of them have store and forward capability, the would-be perpetrators would need to be on their best behaviour at all times because they would never know which heart monitors had such a capability.

Additionally, a number of heart-name tag units may be made, some with a camera, and others lacking a camera, so that would-be perpetrators must be on their best behaviour at all times, not knowing which heart monitors have cameras in them.

It is not necessary to actually have a camera present, to attain deterrence. A conspicuously concealed imaging possibility is quite sufficient. A conspicuously concealed imaging possibility may be referred to as a maybe camera.

Imaging possibilities may be conspicuously concealed behind smoked acrylic, smoked polycarbonate, or the like. Smoked acrylic, smoked polycarbonate, or the like can also be sculpted into very nice jewelry and fashion accessories, or articles for being sewn onto backpacks, satchels, clothing, or even being directly bonded to the human body, for example, with Dermabond (TM) which is commonly used for surgery and repair of wounds.

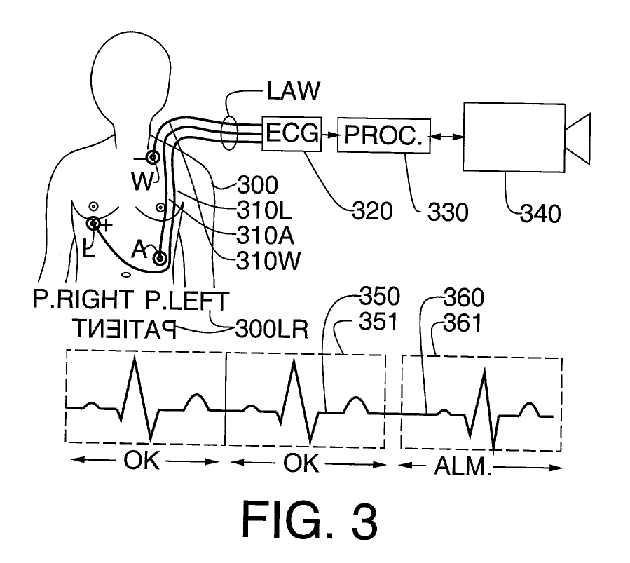

FIG. 3 depicts a personal safety and medical evidence gathering device with electrodes placed in a typical configuration inspired by Einthoven. (Einthoven, using an improved electrometer distinguished five deflections of the meter which he named P, Q, R, S and T, as defined in Einthoven W. Ueber die Form des menschlichen Electrocardiogramms. Archf d Ges Physiol 1895, 60:101-123). Einthoven described (Chelsea Clinical Society in London) an equilateral triangle of what he referred to as leads I, II, and III, now referred to as ‘Einthoven's triangle’. (See Einthoven W. The different forms of the human electrocardiogram and their signification. Lancet 1912(1):853-861)

The connections of FIG. 3 are labelled lead, L (positive terminal), apolarital wire A, and white wire, W. Lead L is the positive terminal, and is usually red. Apoliarity wire A (having no polarity) is the ground, and is usually green. White wire, W is the negative terminal.

The three wires, 310L, 310A, and 310W, respectively, are brought out in a wiring harness or connection LAW.

The wiring is shown as mirror image of patient 300 so that the patient can connect himself or herself more easily, e.g. patient right P. RIGHT is shown at left and patient left P LEFT is shown at right as indicated in backwards “PATIENT” designation 300LR.

Thus the figure is meant to assist the patient connecting the patient's own electrodes, as may be affixed, using electrodes known in the art, or alternatively, preferably by stitches, or other more permanent manner, such as by using Dermabond (TM) wound closure material manufactured by Closure Medical. A nicely designed ECG processor 320 may therefore be permanently or semi-permanently attached. ECG processor 320 is connected to wearable computer processor 330, for logging, monitoring, transmission, etc., as well as for actuation of camera 340. Preferably the apparatus in which processor 330 is worn is itself worn in a pocket of a shirt worn by the wearer. Preferably the apparatus worn in the pocket contains a camera 340 for wearing in a pocket worn housing, wherein the camera 340 is installed to be facing a potential assailant or conversee, when worn in the pocket of a wearer.

Preferably processor 330 captures images from camera 340 continuously, or more continuously, whenever connection LAW is broken or impaired. Thus perpetrators such as lawbreakers attempting to break connection LAW will be captured on video, together with an alarm condition being generated.

A housing will preferably also contain a chemical disincentive to removal, such as a chemical dye (e.g. that sold under the tradename Dye Witness (TM)) arranged to spray an attacker if the connection LAW is broken or tampered with.

A regular heart beat pattern 350 is monitored in time windows 351 to build a template, for correlation. Thus tampering with the device such as by stripping the wearer down and quickly connecting the leads or electrodes to a heart simulator (or the the body of someone else such as a perpetrator) will result in a correlation error, as window template 361 will not line up in the same way on new data waveform 360. Such an irregularity will sound an alarm, which may also remotely notify one or more monitoring sites.

Additionally, image integrity can be protected by signing with an ECG waveform. Thus the wearer's ECG becomes a cryptographic key signature for confirming the authenticity of the video captured by camera 220. Since it is very hard to fake both video and corresponding ECG (being correlated to the video), the video is better authenticated. Thus in addition to timestamps, Global Positioning stamps, etc., body waveform stamps (ECG, brainwaves, EMG, etc.) are used to lock down the video more securely.

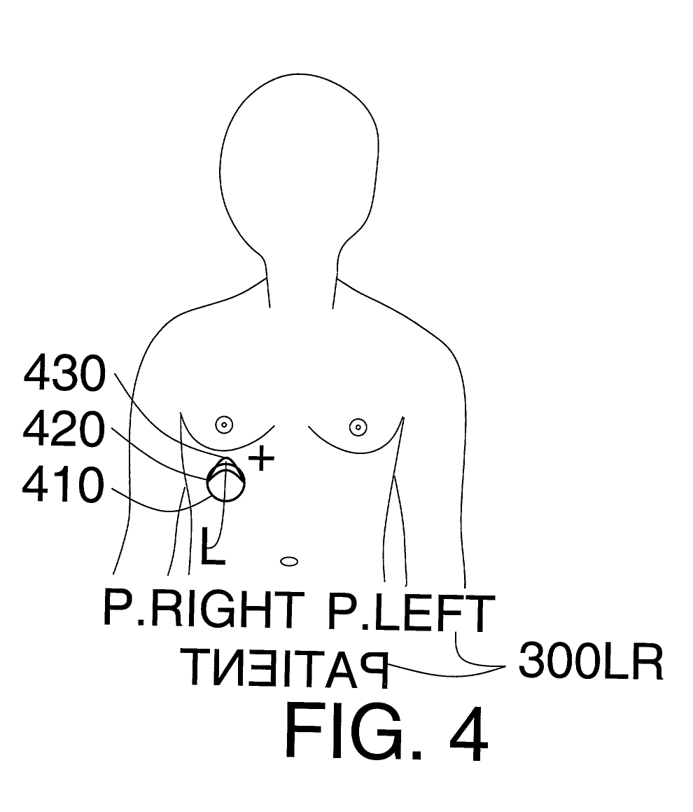

FIG. 4 depicts a more standard form of body modification. The need for more standard body modification arises from the strangeness of Dermabond (TM) approaches to wound closure materials, dermaplants, etc., as being unfamiliar to perpetrators who might conduct a (possibly unlawful) search. Since body piercings are well known, and are quite common, they are often accepted readily, even by airport security, and others who might otherwise object to something less familiar.

In this way, the apparatus can take the form of body art, body jewelerly, etc., and therefore be considered not too unlike a well known and accepted genre.

A ring piercing is made of lead L, so that each ECG lead is a body piercing. In one embodiment, one or more piercings support a camera, housing, and transmitter, or a nonfunctioning decorative camera, housing, and transmitter look-alike.

In one embodiment, ring piercing made of lead L is a loop having an electrode surface portion 430 such as made by a silver and silver chloride coating, as well as an electrical contact portion 410 as made by, for example, a copper plated portion. The ring piercing also preferably has a stop portion 420 that stops it from turning around, and keeps the electrode surface portion 430 in the body.

With permanent electrodes of this manner, continuous lifelong ECG capture is possible because electrode paste can be applied without removal of the electrodes. A little Cardio Cream (TM) can be rubbed into the piercings at various times, as desired by the wearer.

In all aspects of the present invention, references to “camera” mean any device or collection of devices capable of simultaneously determining a quantity of light arriving from a plurality of directions and or at a plurality of locations, or determining some other attribute of light arriving from a plurality of directions and or at a plurality of locations.

References to “processor”, or “computer” shall include sequential instruction, parallel instruction, and special purpose architectures such as digital signal processing hardware, Field Programmable Gate Arrays (FPGAs), programmable logic devices, as well as analog signal processing devices.

From the foregoing description, it will thus be evident that the present invention provides a design for an intelligent personal safety device. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within the scope of the invention, may occur to those skilled in the art upon reviewing the disclosure herein. Such variations or modifications, if within the spirit of this invention, are intended to be encompassed within the scope of any claims to patent protection issuing upon this invention.

The embodiments of the invention in which I claim an exclusive property or privilege are defined as follows: What I claim as my invention is:

1. A personal safety system comprising:
at least one body borne sensor for measuring internal personal data of a bearer of said personal safety system;
a processor for being borne by the body of said bearer, said processor responsive to an output from said sensor;
at least one body borne sensor for measuring incoming personal data of a bearer of said personal safety system;
a data collector for collecting at least some of said incoming personal data;
an incident detector, said collector responsive to an output of said incident detector,
said incident detector detecting at least two levels of probability of incident occurrence, said personal data being collected at a first bandwidth during a first probability of incident occurrence, said personal data being collected at a second bandwidth during a second probability of incident occurrence, said first bandwidth being less than said second bandwidth, and said first probability being lower than said second probability.

2. The personal safety system of claim 1, said internal personal data being data from electrocardiographic signals from said body, said incident detector being a detector of electrocardiographic irregularity.

3. The personal safety system of claim 1, said internal personal data being an ECG, said personal safety system further including a video camera, said video camera activated by said incident detector, video from said video camera being said incoming personal data.

4. The personal safety system of claim 1, said internal personal data being recorded from at least one body piercing.

5. The personal safety system of claim 1, said internal personal data being recorded from at least one implanted device.

6. The personal safety system of claim 1, said internal personal data being recorded from at least one dermaplanted device.

7. The personal safety system of claim 1, said internal personal data being recorded from at least one device bonded to the skin of a wearer, said device being a camera bearing device.

8. The personal safety system of claim 1, further including a notice server, said notice server for serving notice in response to an output from said incident detector.

9. The personal safety system of claim 1, further including a notice daemon, and a location monitor, said notice daemon responsive to an output from said incident detector, said notice daemon responsive to an input from said location monitor, said notice daemon determining a legally responsible entity of a location determined by said location monitor, said notice daemon serving legal notice to said entity.

10. A method of providing personal safety, said method comprising the steps of:
providing sensors for measuring internal personal data of a wearer of said personal safety system, said sensors being worn on a body of said wearer;
processing an output from said sensors;
detection of an incident;
collecting said internal personal data, together with corresponding incoming personal data, said collecting responsive to an output of said detection of an incident,
said detection providing at least two levels of probability of incident occurrence, said personal data being collected at a first bandwidth during a first probability of incident occurrence, said personal data being collected at a second bandwidth during a second probability of incident occurrence, said first bandwidth being less than said second bandwidth, and said first probability being lower than said second probability.

11. A personal safety system comprising:
a plurality of personal safety enhancing devices for being provided to users, each of said plurality of personal safety enhancing devices comprising:
at least one sensor for measuring internal personal data of a bearer of said personal safety device, said sensor for being borne by a body of said bearer;
one of:
a camera housed in a conspicuous concealment housing for being borne by one of said users, and a transmitter for transmitting pictures taken by said camera;
a conspicuous concealment housing lacking a camera, said personal safety system comprising at least one of said personal safety enhancing devices comprising a camera installed in a conspicuous concealment housing for being borne by one of said users, and a transmitter for transmitting pictures taken by said camera,
a processor for being borne by the body of said user, said processor responsive to an output from said sensor;
an incident detector;
a personal data storage device for storing said personal data, said incident detector providing at least two levels of probability of incident occurrence, said personal data being stored at a first bandwidth in said personal data storage device during a first probability of incident occurrence, said personal data being stored at a second bandwidth in said personal data storage device during a second probability of incident occurrence, said first bandwidth being less than said second bandwidth, and said first probability being lower than said second probability.
a network for receiving pictures transmitted by said transmitter.

12. The personal safety system of claim 11, further including a display for being visible to persons interacting with said user, said display responsive to said internal personal data, conspicuousness of said conspicuous concealment being provided by way of the display of at least one picture from said camera.

13. The personal safety system of claim 11, where said internal personal data is electrocardiographic personal data.

14. The personal safety system of claim 13, where said display is for being worn on the left side of said user's chest, said display showing an electrocardiogram of said user.

15. The personal safety system of claim 13, where said display is borne by a housing for being worn on the left side of said user's chest, said display showing an electrocardiogram of said user, said housing also bearing said camera, said conspicuousness of said conspicuous concealment of said camera being provided by way of the display of at least one picture from said camera whenver said user's heart rate exceeds a certain threshold.
